(19) United States
(12) Patent Application Publication
(10) Pub. No.: US 2016/0186418 A1
(43) Pub. Date: Jun. 30, 2016

(54) Wire Control Drain Valve For Bathtub Drainage

(71) Applicant: NINGBO RUNNER INDUSTRIAL CORPORATION, Ningbo (CN)

(72) Inventor: Ding-Yan Yu, Ningbo (CN)

(21) Appl. No.: 14/952,896

(22) Filed: Nov. 25, 2015

(30) Foreign Application Priority Data
Dec. 25, 2014 (CN) 201420840744.X

(51) Int. Cl. E03C 1/232; F16K 1/32; E03C 1/23; F16K 31/50

(52) U.S. Cl. CPC E03C 1/232; F16K 31/508; F16K 1/32; E03C 1/2304; E03C 2001/2315

(57) ABSTRACT

A wire control drain valve for bathtub drainage includes a knob, a control link, an adjustment rod, an inlet cover, an overflow elbow, an adjustment rod and a back cover. The knob is mounted on an overflow lid. The control link is connected with a pulling string. The overflow lid is mounted to an inlet of the overflow elbow. The inlet cover is mounted on an overflow hole of a bathtub, and the control link is mounted inside the overflow elbow. The adjustment rod is connected between the control link and the knob to adjust the control link to longitudinally move. A front portion of the adjustment rod is connected with the knob, and a back portion of the adjustment rod is connected with the control link. A positioning mechanism is mounted between the control link and adjustment rod to position the adjustment rod.

### FIELD OF THE INVENTION

The present invention relates to a drain valve for bathtub drainage and, more particularly, a wire control valve mounted on a sidewall of a bathtub to drain water out, and capable of being mounted on different bathtubs having different thickness of the sidewall.

### DESCRIPTION OF THE RELATED ART

A bathtub drain assembly is used to connect with a drain hole of a bathtub through a pulling wire to drain out water in the bathtub. The bathtub drain assembly generally includes an overflow elbow control valve connected with a drain element with a drain hole communicating with a sewer leading waste water to flow into the sewer. To avoid unintentional water overflow of a bathtub, an overflow hole is formed through a sidewall of the bathtub, and an overflow elbow is connected between the drain hole and a partially hollow-out overflow lid to automatically drain water in the bathtub after the water reaches a specific level. The control valve is normally mounted on the overflow lid and covers the overflow lid for aesthetic concern, and the overflow lid also provides a mounting location for the control valve.

Currently, the control valve includes a knob and a control link. One end of the control link is connected with the knob, the other end of the control link is mounted through the overflow elbow and the overflow elbow and protrudes beyond and the overflow elbow to connect with the pulling string.

Current bathtubs use different materials to manufacture bathtubs with different sidewall thicknesses. However, a length of the control link is fixed. If the length of the is larger than the sidewall thickness of the bathtub, a wide gap between the control link and the bathtub appears to be not aesthetically appealing. If the thickness of the control link is shorter than the sidewall thickness, the knob cannot be connected with the control link. Thus, inconvenience is caused in installation of the bathtub drain assembly. Under the circumstance, the control links with various lengths are manufactured to be used for bathtubs with different sidewall thicknesses and result in many control links with different specifications in the market. Accordingly, it is inconvenient for users to select and is easy to make mistakes upon installation of the wire control drain.

### SUMMARY OF THE INVENTION

In view of the problems and drawbacks of the prior art, the objective of the present invention is to provides a wire control drain valve for bathtub drainage capable of being universally mounted on sidewalls of bathtubs with different thicknesses.

To achieve the foregoing objective, the wire control drain valve for bathtub drainage includes an overflow elbow, an inlet cover, a ferrule, a knob, a control link, an adjustment rod and a positioning mechanism.

The overflow elbow includes an outlet, an inlet and a threaded tube.

The outlet is adapted to connect with an overflow tube.

The inlet is adapted to connect with an overflow hole on a bathtub.

The threaded tube is hollow and externally threaded.

The inlet cover is mounted on the overflow hole, leads water running over the overflow hole to flow to the overflow tube through the overflow elbow, and has a hole formed through the inlet cover.

The knob is mounted on the ferrule and is rotatable with respect to the ferrule.

The control link is mounted inside the overflow elbow.

The adjustment rod is mounted between the control link and the knob and is adjusted to be movable in a longitudinal direction of the control link, and has a front portion, a back portion and a middle portion.

The front portion is connected with the knob.

The back portion is mounted inside the control link to drive the control link.

The middle portion is formed between the front portion and the back portion; a positioning mechanism is formed on the middle portion of the adjustment rod to position the control link.

Preferably, the control link has a first portion and a second portion,

The first portion has a connection hole axially formed through the first portion.

The second portion is connected with a back end of the first portion and protrudes in a direction away from the first portion with a lower end of the second portion connected with a pulling string.

The back portion of the adjustment rod is mounted inside the connection hole of the control link.

Preferably, the positioning mechanism has multiple positioning grooves and a retaining ring.

The multiple positioning grooves are formed in a peripheral wall of the middle portion of the adjustment rod and are spaced apart from each other.

The retaining ring is movably fitted in one of the positioning grooves. The first portion of the control link further has a limit groove and multiple slots.

The limit groove is annularly formed in a peripheral wall of the first portion.

The multiple slots are formed through the peripheral wall of the first portion and communicate with the connection hole of the first portion.

Two free ends of the retaining ring of the control link movably engage one of the multiple positioning grooves through one of the slots.

Preferably, the wire control drain valve further includes an O-ring and a ferrule. The overflow elbow has a threaded tube formed inside the overflow elbow and being hollow and externally threaded. The O-ring and the inlet cover are sequentially mounted inside the overflow elbow and are arranged in an inward direction from the inlet of the overflow elbow. The ferrule is mounted through the hole of the inlet cover and the O-ring and is screwed on the threaded tube. The first portion of the control link is mounted inside the threaded tube of the overflow elbow. The front portion of the adjustment rod is internally threaded and is mounted through the ferrule to protrude beyond the overflow elbow and connect with the knob.

Preferably, the first portion of the adjustment rod is connected to the knob through engagement with a screw. Given the foregoing structure, the movement of the positioning mechanism is easy and convenient and the engagement between the retaining ring and the positioning grooves is secure for positioning. By using the ferrule to fasten the inlet cover and the O-ring on the inlet of the overflow elbow, water in the bathtub can only enter the overflow elbow through the inlet cover, thereby avoid water leakage through gaps of the inlet cover. Meanwhile, the second portion of the control link can be securely positioned to ensure the operation duration of the wire control drain valve. The front portion of the adjustment rod and the knob are connected through a screw to provide a simple assembly and a higher working efficiency.

In sum, the design of the adjustment rod allows the forward and backward movement to change a distance between the knob and the inlet cover for universal installation of the wire control drain valve on bathtubs with different sidewall thicknesses. Accordingly, the wire control drain valve makes selection of the control valves easy and can be easily mounted on any bathtub.

### BRIEF DESCRIPTION OF THE DRAWINGS

The detailed description of the drawings particularly refers to the accompanying figures in which:

FIG. 1 is a perspective view of a wire control drain valve in accordance with the present invention;

FIG. 2 is an exploded perspective view of the wire control drain valve in FIG. 1;

FIG. 3 is a cross-sectional side view of the wire control drain valve in FIG. 1; and

FIG. 4 is a cross-sectional side view of the control link of the wire control drain valve for bathtub drainage.

### DETAILED DESCRIPTION OF THE INVENTION

The purpose, construction, features, functions and advantages of the present invention can be appreciated and understood more thoroughly through the following detailed description with reference to the attached drawings.

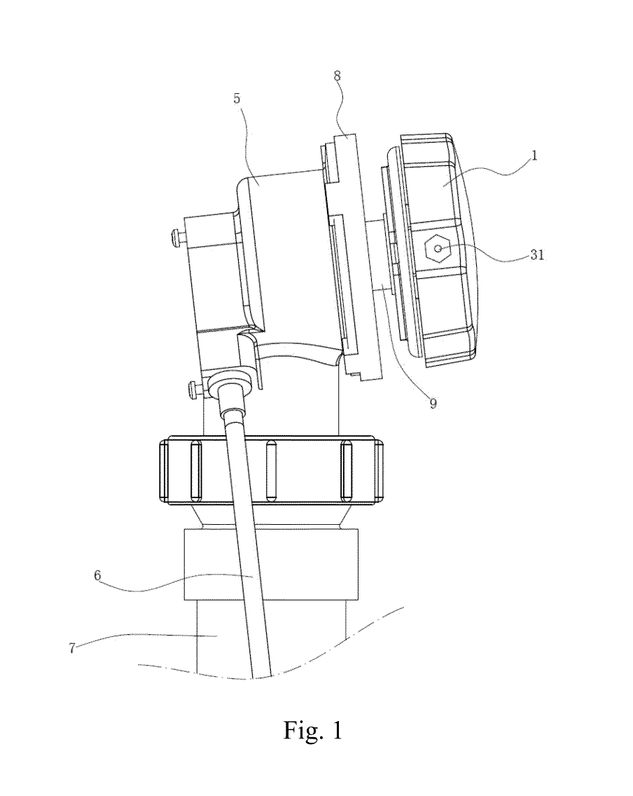

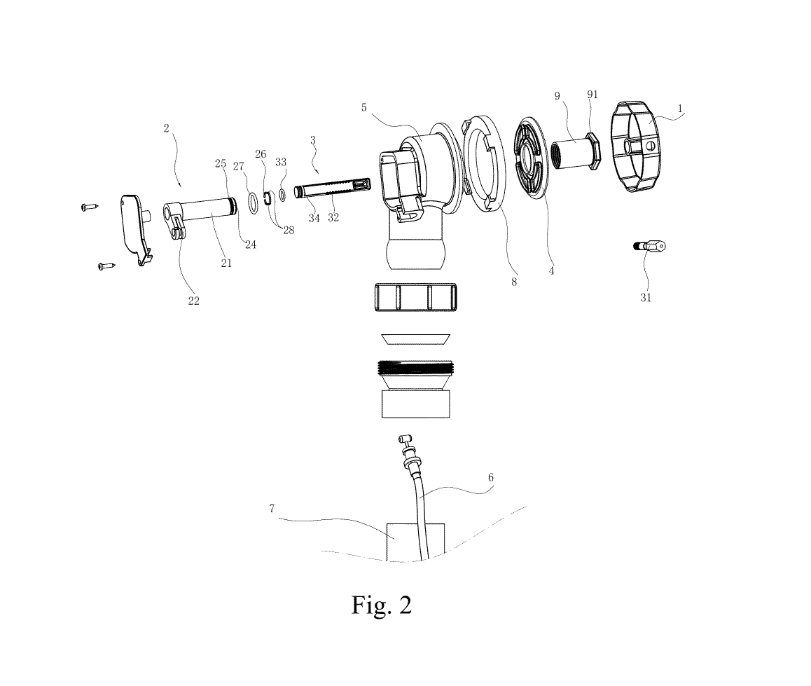

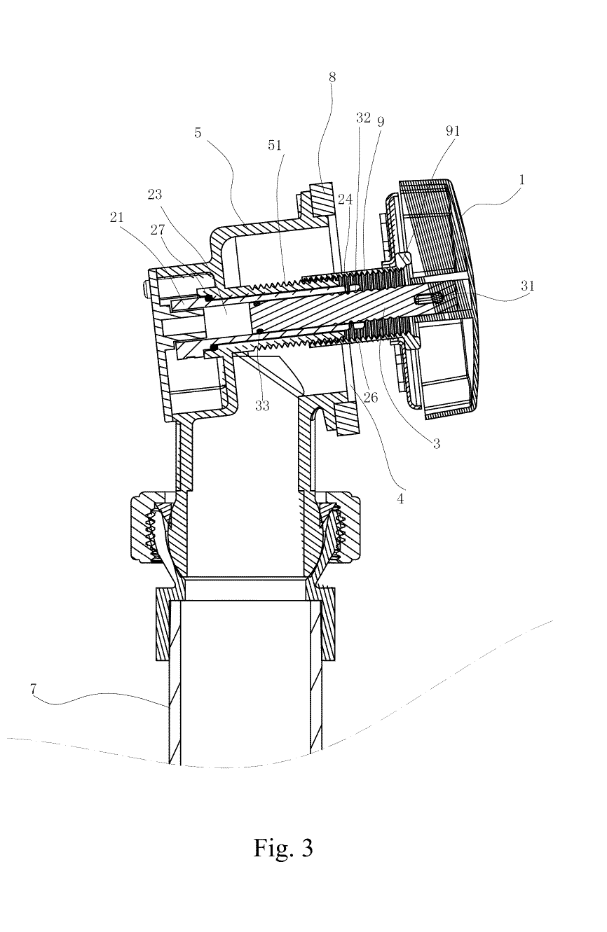

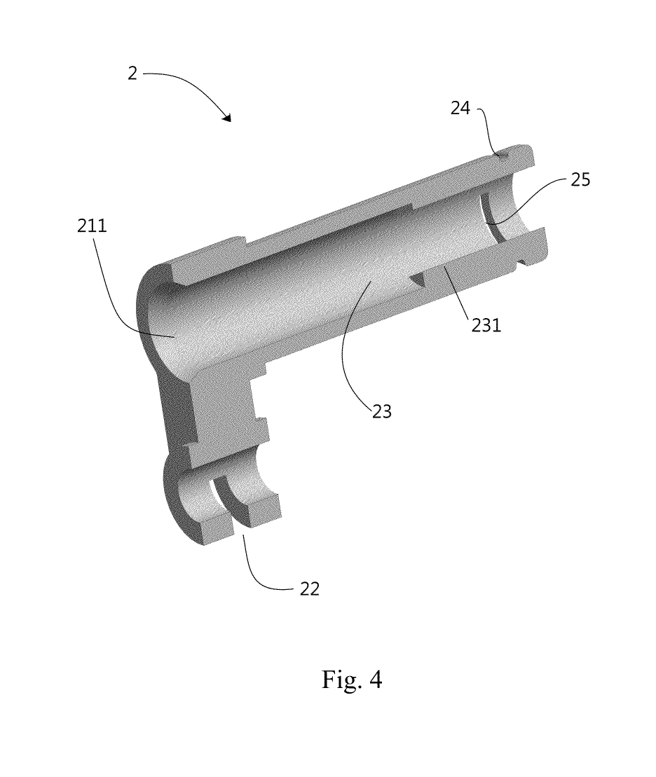

With reference to FIGS. 1-4, a wire control drain valve for bathtub drainage in accordance with the present invention is mounted to an overflow hole on a sidewall of a bathtub and includes an overflow elbow 5, an O-ring 8, an inlet cover 4, a knob 1, a control link 2, and an adjustment rod 3.

The overflow elbow 5 is mounted to the overflow hole of the bathtub and includes an outlet, an inlet, and a threaded tube 51. The inlet is connected to an overflow hole on the sidewall of the bathtub. The outlet of overflow elbow 5 is connected with an overflow tube 7, which is connected with a sewer system, and leads water coming from the overflow hole into the sewer system. The threaded tube 51 is formed inside the overflow elbow 5, and being hollow and externally threaded.

The O-ring 8 and the inlet cover 4 are sequentially mounted inside the overflow elbow 5 and arranged in an inward direction from the inlet of the overflow elbow 5. The O-ring 8 serves to hermetically seal the overflow elbow 5 and the overflow hole to prevent water from permeating from any gap between the overflow hole and the overflow elbow 5.

The inlet cover 4 is partially hollowed out, is mounted on an inner side of the overflow hole, leads water running over the overflow hole to flow to the overflow tube 7 through the overflow elbow 5, and has a hole 41 formed through the inlet cover 4. The hollow threaded tube 51 is integrally formed inside the overflow elbow 5.

A ferrule 9 is mounted through the hole 41 of the inlet cover 4 and the O-ring 8, and is screwed on the threaded tube 51. The inlet cover 4 and the O-ring 8 are hermetically sealed between the inlet of the overflow elbow 5 and a water inlet of the bathtub. The ferrule 9 has a connection seat 91 mounted on an outer end of the ferrule 9.

The knob 1 is mounted on the connection seat 91 so that the knob 1 is rotatable with respect to the connection seat 91. Turning the knob 1 can adjust a distance from the inlet cover 4 to the overflow hole, based on a thickness of the sidewall of the bathtub. The knob 1 has a hole 101 formed in a circumferential edge portion of the knob 1.

The control link 2 is mounted inside the overflow elbow 5, and has a first portion 21 and a second portion 22. The second portion 22 is connected with a back end of the first portion 21 and protrudes in a direction away from the first portion 21. In the present embodiment, the second portion 22 is vertically connected with the first portion 21. The first portion 21 is tubular and is mounted inside the threaded tube 51. The first portion 21 has a connection hole 23, a limit groove 24, multiple slots 25, a retaining ring 26, and a first seal ring 27. The connection hole 23 is axially formed through the first portion 21 and has a back opening 211 and a reduced neck 231. The back opening 211 is located at a back end of the connection hole 23. The reduced neck 231 is formed around a front portion of the connection hole 23. The limit groove 24 is annularly formed in a peripheral wall of the first portion 21. The multiple slots 25 are formed through the peripheral wall of the first portion 21 and communicate with the connection hole 23 of the first portion 21. The retaining ring 26 is fitted in the limit groove 24. A lower portion of the second portion 22 is connected with a pulling string 6. The pulling string 6 is connected with a drain assembly on the bottom of the bathtub.

The adjustment rod 3 serves to adjust a distance between the knob 1 and the sidewall of the bathtub and is slidably movable in a longitudinal direction of the first portion 21 of the control link 2, and includes a front portion, a middle portion, a back portion, multiple positioning grooves 32, a second seal ring 33 and a bump 34. The back portion of the adjustment rod 3 is mounted inside the connection hole 23 of the control link 2. The multiple positioning grooves 32 are formed in a peripheral wall of the middle portion of the adjustment rod 3 and are spaced apart from each other. Two free ends 28 of the retaining ring 26 of the control link 2 movably engage one of the multiple positioning grooves 32 through one of the slots 25. The second seal ring 33 is mounted to seal a portion between the back end of the adjustment rod 3 and the connection hole 23 of the control link 2. The front portion of the adjustment rod 3 is internally threaded and is mounted through the ferrule 9 to protrude beyond the overflow elbow 5 and connect with the knob 1 through engagement with a screw 31 or a pin. The bump 34 is annularly formed around a back portion of the adjustment rod 3. The reduced neck 231 of the control link 2 blocks the bump 34 and limits movement of the adjustment rod 3 within a portion of the connection hole 23 other than the reduced neck 231 in the control link 2.

In the present embodiment, the multiple positioning grooves 32 of the adjustment rod 3 and the retaining ring 26 constitutes a positioning mechanism.

The back cover 11 has an extended portion 111 mounted into the back opening 211 of the control link 2, is mounted on a rear portion of the overflow elbow 5 to cover the rear portion of the overflow elbow 5 by using multiple screws 12 and avoid water flowing out from the rear portion of the overflow elbow 5.

Operation of the wire control drain valve for bathtub drainage is described as follows. For a bathtub with a thin sidewall, the knob 1 is pushed into the overflow hole. Because of the pushing force, the adjustment rod 3 is pushed inwards to push the two free ends 28 of the retaining ring 26 to escape from the engaging positioning grooves 32 of the adjustment rod 3 for the retaining ring 26 to move inwardly to a next inner one of the positioning grooves 32. When the knob 1 is continuously pressed, the adjustment rod 3 can be moved to engage a corresponding inner positioning groove 32 and a distance between the knob 1 and the overflow lid can be adjusted until the distance is exactly equal to a thickness of the sidewall of the bathtub. After release of the knob 1, the adjustment rod 3 is positioned by the retaining ring 26 and the wire control drain valve for bathtub drainage can then be mounted on the sidewall of the bathtub. For a bathtub with a thick sidewall, the knob 1 is pulled outwards to pull the two free ends 28 of the retaining ring 26 to escape from the engaging positioning grooves 32 of the adjustment rod 3 for the retaining ring 26 to move outwardly to a next outer one of the positioning grooves 32. When the knob 1 is continuously pulled, the adjustment rod 3 can be moved to engage a corresponding outer positioning groove 32 and a distance between the knob 1 and the overflow lid can be adjusted until the distance is exactly equal to a thickness of the sidewall of the bathtub. The foregoing operation of the wire control drain valve for bathtub drainage ensures convenient installation of the wire control drain valve for bathtub drainage.

Turning the knob 1 lets the adjustment rod 3 and the control link 2 turn together. Further, the turning of the control link 2 controls a length of the pulling string 6, and then opens or closes a stopper on bottom of the bathtub.

What is claimed is:

1. A wire control drain valve for bathtub drainage comprising:
an overflow elbow including:
an outlet adapted to connect with an overflow tube; and
an inlet adapted to connect with an overflow hole on a bathtub; and
a threaded tube being hollow and externally threaded;
an inlet cover mounted on the overflow hole, leading water running over the overflow hole to flow to the overflow tube through the overflow elbow, and having a hole formed through the inlet cover;
a knob mounted on the ferrule and being rotatable with respect to the ferrule;
a control link mounted inside the overflow elbow;
an adjustment rod mounted between the control link and the knob and adjusted to be movable in a longitudinal direction of the control link and having:
a front portion connected with the knob;
a back portion mounted inside the control link to drive the control link; and
a middle portion formed between the front portion and the back portion; and
a positioning mechanism formed on the middle portion of the adjustment rod to position the control link.

2. The wire control drain valve for bathtub drainage as claimed in claim 1, wherein the control link has:
a first portion having a connection hole axially formed through the first portion; and
a second portion connected with a back end of the first portion and protruding in a direction away from the first portion with a lower end of the second portion connected with a pulling string;
wherein the back portion of the adjustment rod is mounted inside the connection hole of the control link.

3. The wire control drain valve for bathtub drainage as claimed in claim 2, wherein the positioning mechanism has:
multiple positioning grooves formed in a peripheral wall of the middle portion of the adjustment rod and spaced apart from each other; and
a retaining ring movably fitted in one of the positioning grooves;
wherein the first portion of the control link further has:
a limit groove annularly formed in a peripheral wall of the first portion; and
multiple slots formed through the peripheral wall of the first portion and communicating with the connection hole of the first portion;
wherein two free ends of the retaining ring of the control link movably engage one of the multiple positioning grooves through one of the slots.

4. The wire control drain valve for bathtub drainage as claimed in claim 3, further comprising an O-ring and a ferrule, wherein
the overflow elbow has a threaded tube formed inside the overflow elbow and is hollow and externally threaded;
the O-ring and the inlet cover are sequentially mounted inside the overflow elbow and are arranged in an inward direction from the inlet of the overflow elbow;
the ferrule is mounted through the hole of the inlet cover and the O-ring is screwed on the threaded tube;
the first portion of the control link is mounted inside the threaded tube of the overflow elbow; and
the front portion of the adjustment rod is internally threaded and is mounted through the ferrule to protrude beyond the overflow elbow and connect with the knob.

5. The wire control drain valve for bathtub drainage as claimed in claim 4, wherein the first portion of the adjustment rod is connected to the knob through engagement with a screw.

6. The wire control drain valve for bathtub drainage as claimed in claim 1, wherein an extend ring step is formed into of the limit channel, and mounted with the bump to limit move space in the control link.
